(19) United States
(12) Patent Application Publication
(10) Pub. No.: US 2019/0258120 A1
(43) Pub. Date: Aug. 22, 2019

(54) PEEP-PROOF DEVICE AND PEEP-PROOF DISPLAY APPARATUS

(71) Applicants: BOE TECHNOLOGY GROUP CO., LTD., Beijing (CN); BEIJING BOE DISPLAY TECHNOLOGY CO., LTD., Beijing (CN)

(72) Inventors: Yang You, Beijing (CN); Ruizhi Yang, Beijing (CN); Ruiyong Wang, Beijing (CN); Lianjie Qu, Beijing (CN); Yanfeng Wang, Beijing (CN); Huijuan Wang, Beijing (CN)

(73) Assignees: BOE TECHNOLOGY GROUP CO., LTD., Beijing (CN); BEIJING BOE DISPLAY TECHNOLOGY CO., LTD., Beijing (CN)

(21) Appl. No.: 15/779,752

(22) PCT Filed: Sep. 29, 2017
(86) PCT No.: PCT/CN2017/104606

§ 371 Date: May 29, 2018

(30) Foreign Application Priority Data
Mar. 14, 2017 (CN) 201710151889.7

(51) Int. Cl. G02F 1/1337; G02F 1/1335; G02F 1/1343; G02F 1/137

(52) U.S. Cl. CPC G02F 1/133753; G02F 1/133528; G02F 2001/133757; G02F 1/13725; G02F 1/134309

(57) ABSTRACT

A peep-proof device and a peep-proof display apparatus are provided. The peep-proof device includes: a guest-host liquid crystal cell; and a polarizer stacked on the guest-host liquid crystal cell, wherein the guest-host liquid crystal cell comprises a first alignment film, the first alignment film comprising first alignment film portions and second alignment film portions arranged alternately, and each of the first alignment film portions having an alignment direction perpendicular to an alignment direction of each of the second alignment film portions.

### CROSS-REFERENCE TO RELATED APPLICATION

This application is a U.S. National Phase Application of International Application No. PCT/CN2017/104606, filed on Sep. 29, 2017, entitled “PEEP-PROOF DEVICE AND PEEP-PROOF DISPLAY APPARATUS,” which claims benefit to the Chinese Patent Application No. 201710151889.7, filed with the State Intellectual Property Office of China on Mar. 14, 2017, the whole disclosure of which is incorporated herein by reference.

### FIELD OF THE DISCLOSURE

Embodiments of the present disclosure relate to technical field of display, in particular to a peep-proof device and a peep-proof display apparatus.

### BACKGROUND

Display devices are widely used in various applications of the people's lives. Different applications may have different requirements on visual angles of the display devices. The peep-proof films in related art cannot satisfy the peep-proof requirements of the user in the above various environments.

### SUMMARY OF DISCLOSURE

According to an aspect of the present disclosure, there is provided a peep-proof device, comprising: a guest-host liquid crystal cell; and a polarizer stacked on the guest-host liquid crystal cell, wherein the guest-host liquid crystal cell comprises a first alignment film, the first alignment film comprising first alignment film portions and second alignment film portions arranged alternately, and each of the first alignment film portions having an alignment direction substantially perpendicular to an alignment direction of each of the second alignment film portions.

According to an embodiment of the present disclosure, the guest-host liquid crystal cell further comprises a second alignment film and a guest-host liquid crystal layer of the guest-host liquid crystal cell is between the first alignment film and the second alignment film.

According to an embodiment of the present disclosure, the second alignment film comprises third alignment film portions and fourth alignment film portions arranged alternately, and wherein each of the first alignment film portions of the first alignment film is aligned with one of the third alignment film portions of the second alignment film in a thickness direction of the guest-host liquid crystal cell, and the first alignment film portions and the third alignment film portions have same alignment directions, and wherein each of the second alignment film portions of the first alignment film is aligned with one of the fourth alignment film portions of the second alignment film in the thickness direction of the guest-host liquid crystal cell, and the second alignment film portions and the fourth alignment film portions have same alignment directions.

According to an embodiment of the present disclosure, the peep-proof device further comprises: a first electrode on a side of the first alignment film away from the guest-host liquid crystal layer; and a second electrode on a side of the second alignment film away from the guest-host liquid crystal layer.

According to an embodiment of the present disclosure, the peep-proof device further comprises: a first substrate on a side of the first electrode away from the guest-host liquid crystal layer; and a second substrate on a side of the second electrode away from the guest-host liquid crystal layer.

According to an embodiment of the present disclosure, the polarizer is on a light exit side or a light incidence side of the guest-host liquid crystal cell.

According to an embodiment of the present disclosure, the polarizer has a polarization orientation substantially parallel with the alignment direction of the first alignment film portions or the alignment direction of the second alignment film portions.

According to an aspect of the present disclosure, there is provided a peep-proof display apparatus comprising: a display device; and the peep-proof device mentioned above.

According to an embodiment of the present disclosure, the display device is on a light exit side or a light incidence side of the peep-proof device.

According to an embodiment of the present disclosure, the display device is a liquid crystal display device and the peep-proof display apparatus further comprises a backlight device on a light incidence side of the display device.

According to an embodiment of the present disclosure, the peep-proof device is between the display device and the backlight device.

According to an embodiment of the present disclosure, the display device is an organic light emitting diode display device.

According to an aspect of the present disclosure, there is provided a peep-proof display apparatus comprising: a display device; and a guest-host liquid crystal cell, wherein the guest-host liquid crystal cell comprises a first alignment film, the first alignment film comprising first alignment film portions and second alignment film portions arranged alternately, and each of the first alignment film portions having an alignment direction substantially perpendicular to an alignment direction of each of the second alignment film portions.

According to an embodiment of the present disclosure, the guest-host liquid crystal cell further comprises a second alignment film and a guest-host liquid crystal layer of the guest-host liquid crystal cell is between the first alignment film and the second alignment film.

According to an embodiment of the present disclosure, the second alignment film comprises third alignment film portions and fourth alignment film portions arranged alternately, and wherein each of the first alignment film portions of the first alignment film is aligned with one of the third alignment film portions of the second alignment film in a thickness direction of the guest-host liquid crystal cell, and the first alignment film portions and the third alignment film portions have same alignment directions, and wherein each of the second alignment film portions of the first alignment film is aligned with one of the fourth alignment film portions of the second alignment film in the thickness direction of the guest-host liquid crystal cell, and the second alignment film portions and the fourth alignment film portions have same alignment directions.

According to an embodiment of the present disclosure, the display device comprises a polarizer.

According to an embodiment of the present disclosure, the display device is on a light exit side or a light incidence side of the guest-host liquid crystal cell.

According to an embodiment of the present disclosure, the display device is a liquid crystal display device and the peep-proof display apparatus further comprises a backlight device on a light incidence side of the display device.

According to an embodiment of the present disclosure, the peep-proof device is between the display device and the backlight device.

According to an embodiment of the present disclosure, the display device is an organic light emitting diode display device.

### BRIEF DESCRIPTION OF THE DRAWINGS

FIG. 1 is a schematic view showing a structure of a peep-proof device according to an embodiment of the present disclosure;

FIG. 2 is a schematic view showing a structure of an alignment film in a liquid crystal cell shown in FIG. 1;

FIG. 3 is a schematic sectional view showing a peep-proof device according to an exemplified embodiment of the present disclosure;

FIG. 4 is a schematic sectional view showing a peep-proof device according to another exemplified embodiment of the present disclosure;

FIG. 4a is a schematic enlarged sectional view showing light transmission state at a lateral alignment film portion in FIG. 4 when no voltage is applied;

FIG. 4b is a schematic enlarged sectional view showing light transmission state at a longitudinal alignment film portion in FIG. 4 when no voltage is applied;

FIG. 4c is a schematic enlarged sectional view showing light transmission state at the lateral alignment film portion or the longitudinal alignment film portion in FIG. 4 when a voltage is applied;

FIG. 5a is a schematic sectional view showing a light exit path when the peep-proof device shown in FIG. 4 is in a peep-proof mode;

FIG. 5b is a schematic sectional view showing a light exit path when the peep-proof device shown in FIG. 4 is in a non-peep-proof mode;

FIG. 6 is a schematic sectional view showing a peep-proof device according to another exemplified embodiment of the present disclosure;

FIG. 7 is a schematic view showing a structure of a peep-proof display apparatus according to an embodiment of the present disclosure;

FIG. 7a is an example of a structure of a peep-proof display apparatus when the display device in FIG. 7 is a liquid crystal display device;

FIG. 8 is a schematic view showing a structure of a peep-proof display apparatus according to another embodiment of the present disclosure;

FIG. 8a is an example of a structure of a peep-proof display apparatus when the display device in FIG. 8 is a liquid crystal display device;

FIG. 9 is a schematic view showing a structure of a peep-proof display apparatus according to another embodiment of the present disclosure;

FIG. 9a is an example of a structure of a peep-proof display apparatus when the display device in FIG. 9 is a liquid crystal display device;

FIG. 10 is a schematic view showing a structure of a peep-proof display apparatus according to another embodiment of the present disclosure; and

FIG. 10a is an example of a structure of a peep-proof display apparatus when the display device in FIG. 10 is a liquid crystal display device.

### DETAILED DESCRIPTION

With the following description to exemplified embodiments with reference to drawings, other objects, advantages and effects of the present disclosure will be known. In figures, similar components are indicated by same reference numerals.

In order that the objects, technical solutions and advantages of embodiments of the present disclosure may become more apparent, the embodiments of the present disclosure will below be explained in detail with reference to drawings. It should be understood that the following description to the embodiments are intended to interpret and explain the general concept of the present disclosure, instead of limiting the present disclosure. In the description, same or similar reference numerals indicate same or similar components or members.

The terms such as “upper”, “lower”, “top” or “bottom” that are used herein to represent orientations are all intended to indicate orientations that are presented in the drawings. These terms are only intended for convenience of description, instead of limiting the present disclosure. In addition, for the sake of clarity, the drawings are not necessarily drawn to scale.

When a user is in an open environment, for example, if he has private requirements, he needs a narrower visual angle of the display device, so as to achieve a purpose of proof peep; if he has sharing requirements, he needs a wider visual angle of the display device, so as to achieve sharing.

According to an inventive concept of the present disclosure, there is provided a peep-proof device, comprising: a guest-host liquid crystal cell; and a polarizer stacked on the guest-host liquid crystal cell, wherein the guest-host liquid crystal cell comprises a first alignment film, the first alignment film comprising first alignment film portions and second alignment film portions arranged alternately, and each of the first alignment film portions having an alignment direction substantially perpendicular to an alignment direction of each of the second alignment film portions.

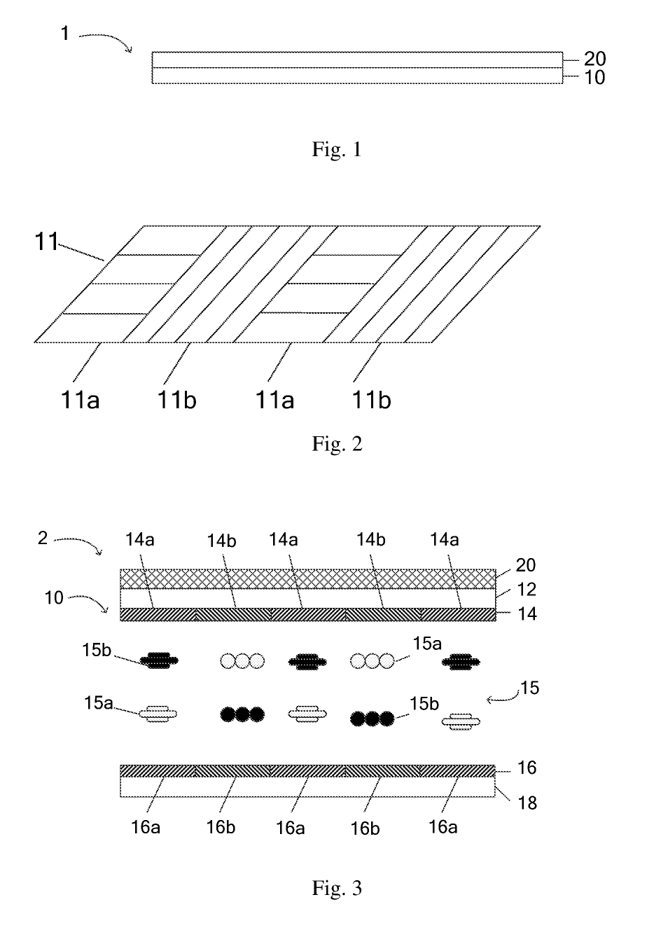

FIG. 1 is a schematic view showing a structure of a peep-proof device according to an embodiment of the present disclosure. FIG. 2 is a schematic view showing a structure of an alignment film of a liquid crystal cell of the peep-proof device shown in FIG. 1.

As shown in FIG. 1 and FIG. 2, a peep-proof device 1 is provided according to an embodiment of the present disclosure. The peep-proof device 1 includes a guest-host liquid crystal cell 10 and a polarizer 20 stacked on the guest-host liquid crystal cell 10. The guest-host liquid crystal cell 10 includes an alignment film 11 shown in FIG. 2. The alignment film 11 is for example a polyimide (PI) film. The polarizer 20 may be a lateral polarizer or a longitudinal polarizer. The lateral polarizer only allows laterally polarized light to pass therethrough. The longitudinal polarizer only allows longitudinally polarized light to pass therethrough.

The guest-host liquid crystal cell 10 contains a layer of guest-host liquid crystal. The guest-host liquid crystal is formed by adding dichroic dyes into conventional liquid crystal. Molecules of the dichroic dyes may be aligned in the same direction as the direction along which liquid crystal molecules are aligned. Further, the molecules of the dichroic dyes are rod-shaped pigment molecules and have very large absorption to the polarized light whose polarization orientation is along a major axis and relatively small absorption to the polarized light whose polarization orientation is along a minor axis. When a polarization orientation of the incident light is parallel to the major axes of the liquid crystal molecules, the light is absorbed substantially by dye molecules without light being emitted out of the guest-host liquid crystal cell. When the polarization orientation of the incident light is perpendicular to the major axes of the liquid crystal molecules, i.e. is paralleled with the minor axis of the liquid crystal molecules, the light may normally pass through the guest-host liquid crystal cell.

As shown in FIG. 2, the alignment film 11 includes first alignment film portions 11a and second alignment film portions 11b arranged alternately. Each of the first alignment film portions 11a has an alignment direction perpendicular to an alignment direction of each of the second alignment film portions 11b. In an example, the alignment direction of the first alignment film portions 11a is lateral and the alignment direction of the second alignment film portions 11b is longitudinal. The arrangement of the liquid crystal molecules and the dye molecules depend on the alignment directions of the alignment films, specifically the liquid crystal molecules and dye molecules at the first alignment film portions 11a are aligned in the lateral direction and these molecules have major axes along the alignment directions of the first alignment film portions 11a. The liquid crystal molecules and dye molecules at the second alignment film portions 11b are aligned in the longitudinal direction and these molecules have major axes along the alignment directions of the second alignment film portions 11b. The liquid crystal molecules and dye molecules at the first alignment film portions 11a are aligned along the direction perpendicular to the direction along which the liquid crystal molecules and dye molecules at the second alignment film portions 11b are aligned.

In the peep-proof device 1 according to the above embodiment, if the polarizer 20 is a longitudinal polarizer, when the light reaches the liquid crystal cell 10 from bottom (light incidence side) of the liquid crystal cell 10, the laterally polarized light component of the light passes through the liquid crystal cell 10 at the first alignment film portions 11a to reach the polarizer 20, while the longitudinally polarized light component of the light is blocked by the first alignment film portions 11a and thus cannot pass through the liquid crystal cell 10. Further, the laterally polarized light component that has passed through the liquid crystal cell 10 to reach the light incidence side of the polarizer 20 cannot pass through the polarizer 20, thus regions corresponding to the first alignment film portions 11a on a top side (light exit side) of the peep-proof device 1 is presented in a dark state. On the other hand, at the second alignment film portions 11b, the longitudinally polarized light component of the light passes through the liquid crystal cell 10 to reach the polarizer 20, while the laterally polarized light component of the light is blocked by the second alignment film portions 11b and thus cannot pass through the liquid crystal cell 10. Further, the longitudinally polarized light component that has passed through the liquid crystal cell 10 to reach the light incidence side of the polarizer 20 may pass through the polarizer 20, thus a region corresponding to the second alignment film portion 11b on the top side (light exit side) of the peep-proof device 1 is presented in a bright state.

Although the longitudinal polarizer is described taken as an example of the polarizer 20 in the above embodiments, the skilled person in the art will understand that, same effects may also be achieved in case that the polarizer 20 is a lateral polarizer.

Thus, the above embodiment of the present disclosure provides a peep-proof device based on the guest-host liquid crystal cell. In the peep-proof device, the alignment film in the guest-host liquid crystal cell is arranged to include the first alignment film portions and the second alignment film portions arranged alternately and each of the first alignment film portions has an alignment direction substantially perpendicular to the alignment direction of each of the second alignment film portions. Here, the wording “substantially” mean a processing error or machining error may be included. Thus, after the light has passed through the liquid crystal cell and the polarizer, the regions corresponding to the first alignment film portions in the peep-proof device are presented as portions in bright state while the regions corresponding to the second alignment film portions in the peep-proof device are presented as portions in dart state. The portions in bright state allow the incident light to pass therethrough while the portions in dark state do not allow the incident light to pass therethrough, so as to limit light emitting angle, and to supply a narrow visual angle for proof peeping.

FIG. 3 is a schematic sectional view showing a peep-proof device 2 according to an exemplified embodiment of the present disclosure. As shown in FIG. 3, the peep-proof device 2 according to the embodiment includes the liquid crystal cell 10 and the polarizer 20. The polarizer 20 is on the light exit side of the liquid crystal cell 10, in particular on the top side of the liquid crystal cell 10 in FIG. 3. The liquid crystal cell 10 includes from top to below an upper substrate 12, an upper alignment film 14, a liquid crystal layer 15, a lower alignment film 16 and a lower substrate 18. The liquid crystal layer 15 is a guest-host liquid crystal layer sandwiched between the upper alignment film 14 and the lower alignment film 16. The guest-host liquid crystal layer includes liquid crystal molecules 15a and dye molecules 15b.

In accordance with the embodiment, the upper alignment film 14 includes the first alignment film portions 14a and the second alignment film portions 14b arranged alternately. The alignment direction of the first alignment film portions 14a is lateral and the alignment direction of the second alignment film portions 14b is longitudinal. The lower alignment film 16 includes the third alignment film portions 16a and the fourth alignment film portions 16b arranged alternately. The alignment direction of the third alignment film portions 16a is lateral and the alignment direction of the fourth alignment film portions 16b is longitudinal. Further, each of the first alignment film portions 14a of the upper alignment film 14 is aligned with one of the third alignment film portions 16a of the lower alignment film 16 in a direction perpendicular to the upper alignment film or the lower alignment film, and each of the second alignment film portions 14b of the upper alignment film 14 is aligned with one of the fourth alignment film portions 16b of the lower alignment film 16 in a direction perpendicular to the upper alignment film or the lower alignment film.

In accordance with the above arrangement of the upper alignment film 14 and the lower alignment film 16, the liquid crystal molecules 15a and the dye molecules 15b at the first alignment film portions 14a are arranged laterally along a direction parallel to the upper alignment film 14 or the lower alignment film 16, and the liquid crystal molecules 15a and the dye molecules 15b at the second alignment film portions 14b are arranged longitudinally along a direction parallel to the upper alignment film 14 or the lower alignment film 16. Thus, when the light including the laterally polarized light component and the longitudinally polarized light component, for example natural light, is incident onto the light incidence side (bottom side here) of the peep-proof device 2, i.e., is incident onto the liquid crystal cell 10, the dye molecules 15b between the first alignment film portions 14a and the third alignment film portions 16a absorb the laterally polarized light component while only allowing the longitudinally polarized light component to pass therethrough. On the other hand, the dye molecules 15b between the second alignment film portions 14b and the fourth alignment film portions 16b absorb the longitudinally polarized light component while only allowing the laterally polarized light component to pass therethrough.

In this way, the longitudinally polarized light component exits from the regions corresponding to the first alignment film portions 14a on the light exit side of the liquid crystal cell 10 and the laterally polarized light component exits from the regions corresponding to the second alignment film portions 14b on the light exit side of the liquid crystal cell 10. After the longitudinally polarized light component and the laterally polarized light component further pass through the laterally or longitudinally polarized light 20, one of the laterally polarized light component and the longitudinally polarized light component is blocked while the other of the laterally polarized light component and the longitudinally polarized light component passes through the polarizer 20. Thus, regions in bright state and regions in dark state are presented to be arranged alternately on the light exit side (top side) of the peep-proof device 2, so as to provide a narrow visual angle and thus to achieve peep-proof.

In accordance with a variant of the embodiment shown in FIG. 3, as long as one alignment film is sufficient to align the liquid crystal molecules between the upper substrate 12 and the lower substrate 18, one of the upper alignment film 14 and the lower alignment film 16 may be dispensed and may be replaced with other light transmission film. In addition, it is shown in FIG. 3 that the polarizer 20 and the liquid crystal cell 10 are formed as an integral structure, but the polarizer 20 and the liquid crystal cell 10 may also be separated components according to a variant of the embodiment.

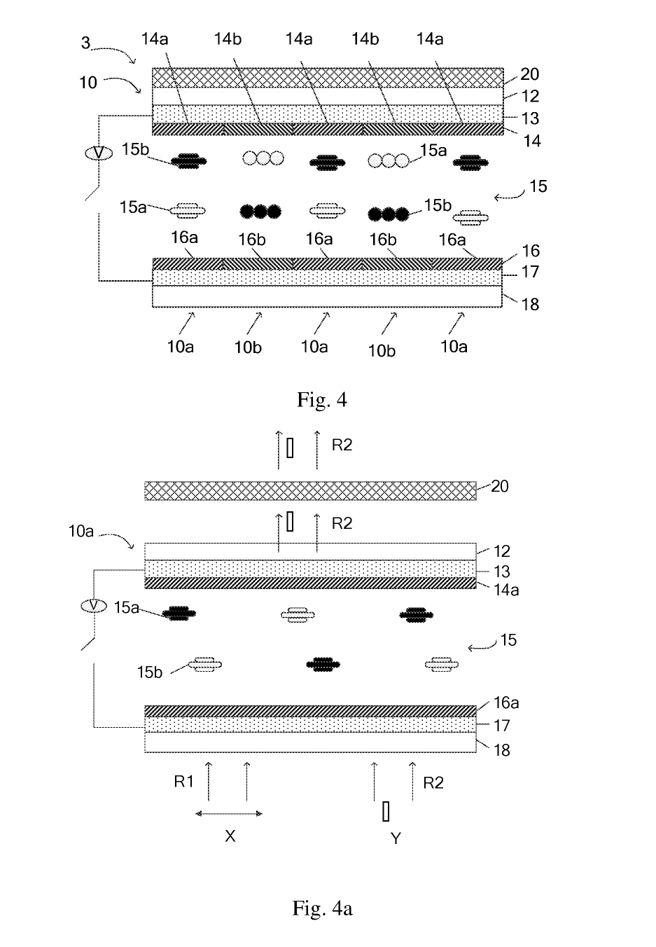

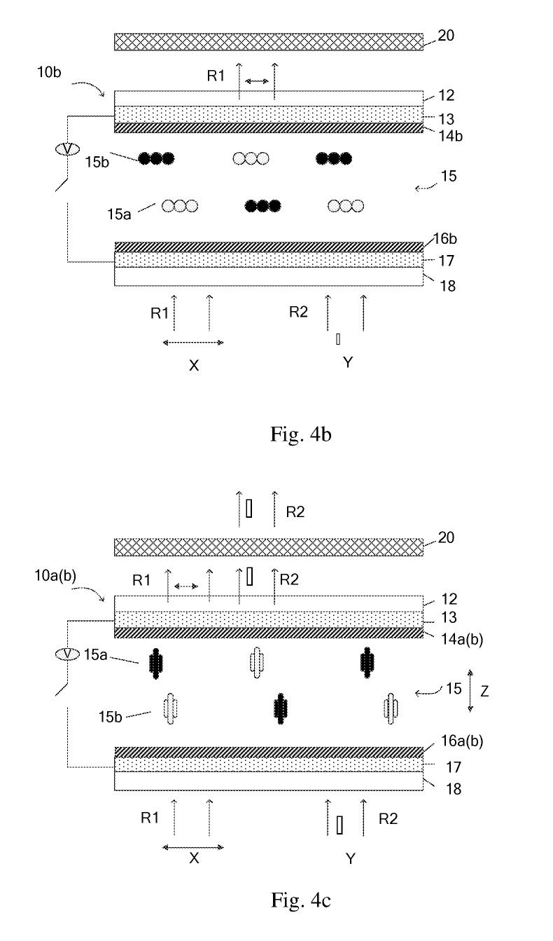

FIG. 4 is a schematic sectional view showing a peep-proof device 3 according to another exemplified embodiment of the present disclosure. As shown in FIG. 4, the peep-proof device 3 according to the embodiment includes the liquid crystal cell 10 and the polarizer 20. The polarizer 20 is on the light exit side of the liquid crystal cell 10. The liquid crystal cell 10 includes from top to below an upper substrate 12, an upper electrode 13, an upper alignment film 14, a liquid crystal layer 15, a lower alignment film 16, a lower electrode 17 and a lower substrate 18. The liquid crystal layer 15 is a guest-host liquid crystal layer sandwiched between the upper alignment film 14 and the lower alignment film 16. The guest-host liquid crystal layer includes liquid crystal molecules 15a and dye molecules 15b. In contrast to the embodiment shown in FIG. 3, the peep-proof device 3 according to the embodiment shown in FIG. 4 further includes the upper electrode 13 and the lower electrode 17. The upper electrode 13 is arranged on a side of the upper alignment film 14 away from the liquid crystal layer 15. The lower electrode 17 is arranged on a side of the lower alignment film 16 away from the liquid crystal layer 15. Optionally, a voltage may be applied or may not be applied between the upper electrode 13 and the lower electrode 17. When a voltage is applied, the liquid crystal molecules 15a and the dye molecules 15b are deflected to be arranged along a direction perpendicular to the upper substrate 12 or the lower substrate 18.

When no voltage is applied between the upper electrode 13 and the lower electrode 17, the peep-proof device 3 of the embodiment has a function similar to the embodiment shown in FIG. 3. Specifically, the upper alignment film 14 includes the first alignment film portions 14a and the second alignment film portions 14b arranged alternately. The alignment direction of the first alignment film portions 14a is lateral and the alignment direction of the second alignment film portions 14b is longitudinal. The lower alignment film 16 includes the third alignment film portions 16a and the fourth alignment film portions 16b arranged alternately. The alignment direction of the third alignment film portions 16a is lateral and the alignment direction of the fourth alignment film portions 16b is longitudinal. Further, each of the first alignment film portions 14a of the upper alignment film 14 is aligned with one of the third alignment film portions 16a of the lower alignment film 16 in a direction perpendicular to the upper alignment film or the lower alignment film, and each of the second alignment film portions 14b of the upper alignment film 14 is aligned with one of the fourth alignment film portions 16b of the lower alignment film 16 in the direction perpendicular to the upper alignment film or the lower alignment film. Below, the portion of the liquid crystal cell 10 corresponding to the first alignment film portions 14a and the third alignment film portions 16a are referred to as a lateral alignment film portion (first liquid crystal cell portion) 10a and the portion of the liquid crystal cell 10 corresponding to the second alignment film portions 14b and the fourth alignment film portions 16b are referred to as a longitudinal alignment film portion (second liquid crystal cell portion) 10b.

In accordance with such arrangement of the upper alignment film 14 and the lower alignment film 16, the liquid crystal molecules 15a and the dye molecules 15b at the lateral alignment film portion 10a are arranged laterally along a direction parallel to the upper alignment film 14 or the lower alignment film 16, and the liquid crystal molecules 15a and the dye molecules 15b at the longitudinal alignment film portion 16b are arranged longitudinally along a direction parallel to the upper alignment film 14 or the lower alignment film 16. Thus, when the light including the laterally polarized light component and the longitudinally polarized light component, for example natural light, is incident onto the light incidence side (bottom side here) of the peep-proof device 3, i.e., is incident onto the liquid crystal cell 10, the dye molecules 15b between the first alignment film portions 14a and the third alignment film portions 16a absorb the laterally polarized light component while only allowing the longitudinally polarized light component to pass therethrough. Further the dye molecules 15b between the second alignment film portions 14b and the fourth alignment film portions 16b absorb the longitudinally polarized light component while only allowing the laterally polarized light component to pass therethrough.

In this way, the longitudinally polarized light component exits from the regions corresponding to the first alignment film portions 14a on the light exit side of the liquid crystal cell 10 and the laterally polarized light component exits from the regions corresponding to the second alignment film portions 14b on the light exit side of the liquid crystal cell 10. After the longitudinally polarized light component and the laterally polarized light component further pass through the lateral or longitudinal polarizer 20, one of the laterally polarized light component and the longitudinally polarized light component is blocked while the other of the laterally polarized light component and the longitudinally polarized light component passes through the polarizer 20. Thus, regions in bright state and regions in dark state are presented to be arranged alternately on the light exit side (top side) of the peep-proof device 3, so as to provide a narrow visual angle and thus to achieve peep-proof.

FIG. 4a is a schematic enlarged sectional view showing light transmission state at a lateral alignment film portion 10a in FIG. 4 when no voltage is applied between the upper electrode 13 and the lower electrode 17. As shown in FIG. 4a, when no electric field is applied, the liquid crystal molecules 15a and the dye molecules 15b are arranged laterally parallel to the upper alignment film 14 or the lower alignment film 16 depending on the alignment direction of the lateral alignment film portion 10a (14a and 16a), that is, major axes of the liquid crystal molecules 15a and the dye molecules 15b extend along the lateral direction (X direction) parallel to the upper alignment film 14 or the lower alignment film 16. At this time, when incident lights include lights in two polarization directions, the polarized light component R1 parallel to the major axes of the dye molecules 15b (i.e., the lateral polarized light component) is absorbed by the first liquid crystal cell portion 10a and only the polarized light component R2 perpendicular to the major axes of the dye molecules 15b (i.e., the longitudinal polarized light component) may pass through the first liquid crystal cell portion 10a. The longitudinal polarized light component R2 further passes through the polarizer 20 with longitudinal transmission axis Y and then the light R2 is finally emitted such that the corresponding portion is presented in a bright state. The arrow X in the figure indicates the lateral direction parallel to the upper alignment film 14 or the lower alignment film 16. The circle Y indicates the longitudinal direction parallel to the upper alignment film 14 or the lower alignment film 16.

FIG. 4b is a schematic enlarged sectional view showing light transmission state at the longitudinal alignment film portion (second liquid crystal cell portion) 10b in FIG. 4 when no voltage is applied between the upper electrode 13 and the lower electrode 17. As shown in FIG. 4b, when no electric field is applied, the liquid crystal molecules 15a and the dye molecules 15b are arranged longitudinally parallel to the upper alignment film 14 or the lower alignment film 16 depending on the alignment direction of the longitudinal alignment film portion 10b (14b and 16b), that is, major axes of the liquid crystal molecules 15a and the dye molecules 15b extend along the longitudinal direction (Y direction) parallel to the upper alignment film 14 or the lower alignment film 16. At this time, when incident lights include lights in two polarization directions, the polarized light component (i.e., the longitudinal polarized light component) R2 parallel to the major axes of the dye molecules 15b is absorbed by the second liquid crystal cell portion 10b and only the polarized light component (i.e., the lateral polarized light component) R1 perpendicular to the major axes of the dye molecules 15b may pass through the first liquid crystal cell. The lateral polarized light component R1 that has passed through the second liquid crystal cell portion 10b is blocked by the polarizer 20 with longitudinal transmission axis Y. No light is emitted out such that the corresponding portion is presented in a dark state. The arrow X in the figure indicates the lateral direction parallel to the upper alignment film 14 or the lower alignment film 16. The circle Y indicates the longitudinal direction parallel to the upper alignment film 14 or the lower alignment film 16.

FIG. 4c is a schematic enlarged sectional view showing light transmission state at the lateral alignment film portion 10a or the longitudinal alignment film portion 10b in FIG. 4 when a voltage is applied between the upper electrode 13 and the lower electrode 17. At this time, an electric field is applied to the guest-host liquid crystal cell 10, in spite of the alignment of the alignment film portion, the liquid crystal molecules 15a and the dye molecules 15b are deflected under the effect of the electric field such that the major axes of the dye molecules 15b are along a direction perpendicular to a surface of the liquid crystal cell (Z direction), instead of being arranged along the alignment directions of the alignment films 14 and 16. At this time, the dye molecules 15b do not absorb any light beams which are incident parallel to the major axes of the dye molecules 15b, thus, both the laterally polarized light component R1 and the longitudinally polarized light component R2 pass through the liquid crystal layer 15, to reach the light exit side of the liquid crystal cell 10 (10a or 10b). Then, after the laterally polarized light component R1 and the longitudinally polarized light component R2 that reach the light exit side of the liquid crystal cell 10 pass through the polarizer 20 with the longitudinal transmission axis Y, the laterally polarized light component R1 is blocked and the longitudinally polarized light component R2 is emitted out, such that the corresponding portion is presented in the bright state. The arrow X in the figure indicates the lateral direction parallel to the upper alignment film 14 or the lower alignment film 16. The circle Y indicates the longitudinal direction parallel to the upper alignment film 14 or the lower alignment film 16. The arrow Z indicates a vertical direction. It should be noted that, at this time, light is emitted from both the lateral alignment film portions 10a and the longitudinal alignment film portions 10b and the lateral alignment film portions 10a and the longitudinal alignment film portions 10b are in the bright state, that is, whole liquid crystal cell 10 is presented in the bright state. In this state, the peep-proof device 3 is in a full-transparent and in a full visual angle observation state, that is, non-peep-proof state.

As discussed above, according to the embodiment, by means of providing the upper and lower electrode structure, the peep-proof device may be switched into the non-peep-proof mode for full visual angle display when the voltage is applied to the guest-host liquid crystal layer through the upper electrode and the lower electrode while the peep-proof device is in a peep-proof mode for narrow visual angle display when no voltage is applied. Thus, the peep-proof device of the embodiment may be used to actively select whether the peep-proof is activated or not, depending on ambient environments, that is, to achieve a dynamical adjustment of a narrow visual angle and a wide visual angle, and a free switching between the peep-proof mode and the non-peep-proof mode.

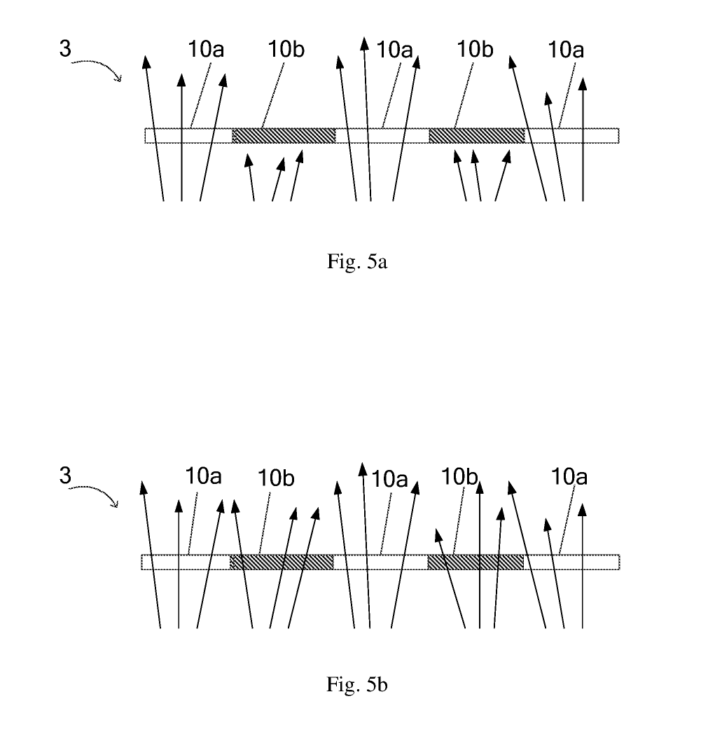

FIG. 5a is a schematic sectional view showing a light exit path when the peep-proof device 3 shown in FIG. 4 is in the peep-proof mode. As shown in FIG. 5a, when no voltage is applied, the peep-proof device 3 is in the peep-proof mode. As discussed above with reference to FIG. 4a to FIG. 4b, the regions corresponding to the lateral alignment film portions 10a and the regions corresponding to the longitudinal alignment film portions 10b are presented in the bright state and in the dark state respectively. The peep-proof device 3 displays transparent stripes and black stripes. Only the light R at special positions or with special angles may be transmitted through the transparent stripes and the light at other positions or with other angles will be blocked by the black stripes. Thus, the peep-proof device is in the narrow visual angle display state, that is, in the peep-proof mode.

FIG. 5b is a schematic sectional view showing a light exit path when the peep-proof device shown in FIG. 4 is in the non-peep-proof mode. As shown in FIG. 5b, when a voltage is applied, the peep-proof device 3 is in the non-peep-proof mode. As discussed above with reference to FIG. 4c, the peep-proof device 3 is in the full-transparent state. Both the regions corresponding to the lateral alignment film portions 10a and the regions corresponding to the longitudinal alignment film portions 10b are presented in the bright state, and there are no bright and dark stripes. Thus, the light R may freely pass through the lateral alignment film portions 10a and the longitudinal alignment film portions 10b without any shades. Thus, the peep-proof device 3 is in the full visual angle state, that is, in the non-peep-proof mode.

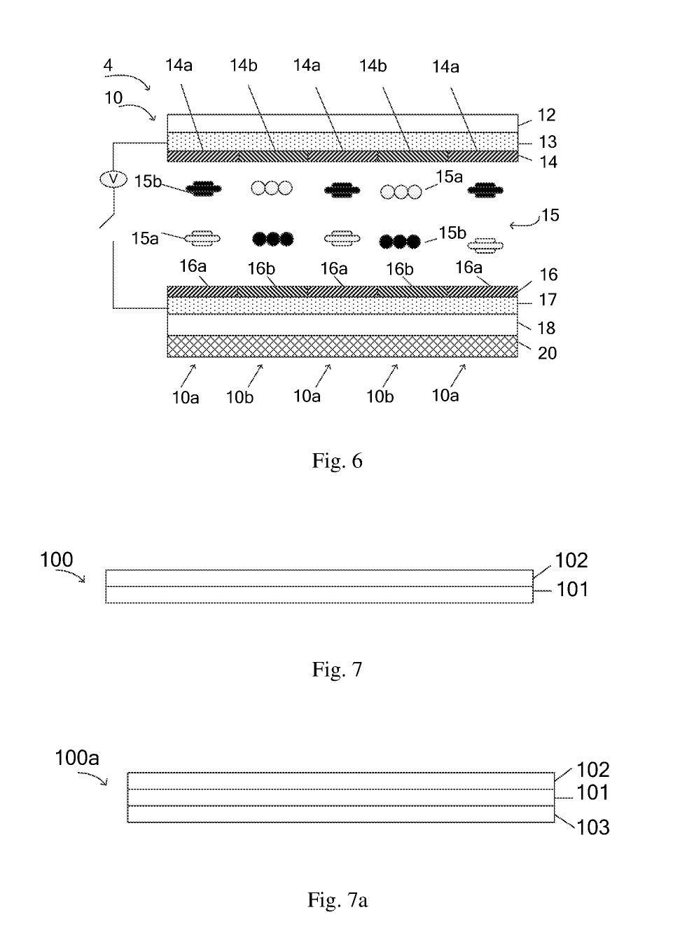

The embodiments shown in FIG. 1 to FIG. 4 illustrate cases that the polarizer 20 is located on the light exit side of the liquid crystal cell 10. However, the polarizer 20 may also be located on the light incidence side of the liquid crystal cell 10. FIG. 6 is a schematic sectional view of the peep-proof device 4 according to an exemplified embodiment of the present disclosure and shows the case that the polarizer 20 is located on the light incidence side of the liquid crystal cell 10.

In particular, as shown in FIG. 6, the peep-proof device 4 according to the embodiment includes the liquid crystal cell 10 and the polarizer 20. The polarizer 20 is arranged on the light incidence side of the liquid crystal cell 10 (specifically on the bottom side of the liquid crystal cell 10 in FIG. 6). The liquid crystal cell 10 includes from top to below an upper substrate 12, an upper electrode 13, an upper alignment film 14, a liquid crystal layer 15, a lower alignment film 16, a lower electrode 17 and a lower substrate 18. The liquid crystal layer 15 is a guest-host liquid crystal layer sandwiched between the upper alignment film 14 and the lower alignment film 16. The guest-host liquid crystal layer includes liquid crystal molecules 15a and dye molecules 15b. In contrast to the embodiment shown in FIG. 4, in the peep-proof device 4 according to the embodiment shown in FIG. 6, the polarizer 20 is arranged on the light incidence side of the liquid crystal cell 10, that is, is arranged on the side of the lower substrate 18 away from the liquid crystal layer 15.

Similar to the embodiment in FIG. 4, when no voltage is applied between the upper electrode 13 and the lower electrode 17, the peep-proof device 4 is in the peep-proof mode. In particular, similar to FIG. 2, the upper alignment film 14 includes the first alignment film portions 14a and the second alignment film portions 14b arranged alternately. The alignment direction of the first alignment film portions 14a is lateral and the alignment direction of the second alignment film portions 14b is longitudinal. The lower alignment film 16 includes the third alignment film portions 16a and the fourth alignment film portions 16b arranged alternately. The alignment direction of the third alignment film portions 16a is lateral and the alignment direction of the fourth alignment film portions 16b is longitudinal. Further each of the first alignment film portions 14a of the upper alignment film 14 is aligned with one of the third alignment film portions 16a of the lower alignment film 16 in a direction perpendicular to the upper alignment film or the lower alignment film, and each of the second alignment film portions 14b of the upper alignment film 14 is aligned with one of the fourth alignment film portions 16b of the lower alignment film 16 in the direction perpendicular to the upper alignment film or the lower alignment film. Below, the portion of the liquid crystal cell 10 corresponding to the first alignment film portions 14a and the third alignment film portions 16a are referred to as a lateral alignment film portion 10a and the portion of the liquid crystal cell 10 corresponding to the second alignment film portions 14b and the fourth alignment film portions 16b are referred to as a longitudinal alignment film portion 10b.

In accordance with such arrangement of the upper alignment film 14 and the lower alignment film 16, the liquid crystal molecules 15a and the dye molecules 15b at the lateral alignment film portion 10a are arranged laterally, and the liquid crystal molecules 15a and the dye molecules 15b at the longitudinal alignment film portion 10b are arranged longitudinally. Thus, when the light including the laterally polarized light component and the longitudinally polarized light component, for example natural light, is incident onto the light incidence side (bottom side here) of the peep-proof device 4, i.e., is incident onto the polarizer 20, if the polarizer 20 is the lateral polarizer, the longitudinally polarized light component is blocked by the polarizer 20 while the laterally polarized light component passes through the polarizer 20. Then, the dye molecules 15b at the first alignment film portions 14a and at the third alignment film portions 16a (at the lateral alignment film portion 10a) absorb the laterally polarized light component instead of allowing the laterally polarized light component to pass through the liquid crystal layer 15. Thus, no lights are outputted from the lateral alignment film portion 10a on the light exit side (top side) of the liquid crystal cell 10 and thus the lateral alignment film portion 10a is presented in the dark state. At the same time, the dye molecules 15b at the second alignment film portions 14b and at the fourth alignment film portions 16b (at the longitudinal alignment film portion 10b) do not absorb the laterally polarized light component, but allow the laterally polarized light component to pass through the liquid crystal layer 15. Thus, lights are outputted from the longitudinal alignment film portion 10b on the light exit side (top side) of the liquid crystal cell 10 and thus the longitudinal alignment film portion 10b is presented in the bright state. In this way, the regions in the bright state and the regions in the dark state are also presented alternately on the light exit side of the peep-proof device 4, so as to provide a narrow visual angle to achieve peep-proof.

Similarly, if the polarizer 20 is the longitudinal polarizer, the longitudinally polarized light component is blocked by the polarizer 20 while the longitudinally polarized light component passes through the polarizer 20. Then, the dye molecules 15b at the first alignment film portions 14a and at the third alignment film portions 16a (at the lateral alignment film portion 10a) do not absorb the longitudinally polarized light component, but allow the longitudinally polarized light component to pass through the liquid crystal layer 15. Thus, lights are outputted from the lateral alignment film portion 10a on the light exit side (top side) of the liquid crystal cell 10 and thus the lateral alignment film portion 10a is presented in the bright state. At the same time, the dye molecules 15b at the second alignment film portions 14b and at the fourth alignment film portions 16b (at the longitudinal alignment film portion 10b) absorb the longitudinally polarized light component, instead of allowing the longitudinally polarized light component to pass through the liquid crystal layer 15. Thus, no lights are outputted from the longitudinal alignment film portion 10b on the light exit side (top side) of the liquid crystal cell 10 and thus the longitudinal alignment film portion 10b is presented in the dark state. In this way, the regions in the bright state and the regions in the dark state are also arranged alternately on the light exit side of the peep-proof device 4, so as to provide a narrow visual angle to achieve peep-proof.

Similar to the embodiment in FIG. 4, when a voltage is applied between the upper electrode 13 and the lower electrode 17, the peep-proof device 4 shown in FIG. 6 is in non-peep-proof mode in full visual angle. In particular, an electric field is applied to the guest-host liquid crystal cell 10, in spite of the alignment of the alignment film portion, the liquid crystal molecules 15a and the dye molecules 15b are deflected under the effect of the electric field such that the major axes of the liquid crystal molecules 15a and the dye molecules 15b are along a direction perpendicular to a surface of the liquid crystal cell 10, instead of being arranged along the alignment directions of the alignment films 14 and 16. At this time, the dye molecules 15b do not absorb any light beams which are incident parallel to the major axes of the dye molecules 15b, thus, whether the polarizer 20 is the lateral polarizer or the longitudinal polarizer, that is, whether the light passing through the polarizer 20 is the laterally polarized light component or the longitudinally polarized light component, the light passing through the polarizer 20 may pass through the liquid crystal layer 15 through the lateral alignment film portions 10a and the longitudinal alignment film portions 10b, to reach the light exit side of the liquid crystal cell 10. At this time, light is emitted from both the lateral alignment film portions 10a and the longitudinal alignment film portions 10b and the lateral alignment film portions 10a and the longitudinal alignment film portions 10b are in the bright state, that is, whole liquid crystal cell 10 is presented in the bright state. In this state, the peep-proof device 4 is in the full-transparent and in the full visual angle observation state, that is, a non-peep-proof state.

As discussed above, according to the embodiment, by means of providing the upper and lower electrode structures, the peep-proof device may be switched into the non-peep-proof mode for full visual angle display when the voltage is applied to the guest-host liquid crystal layer through the upper electrode and the lower electrodes while the peep-proof device is in a peep-proof mode for a narrow visual angle display when no voltage is applied. Thus, the peep-proof device of the embodiment may also be used to actively select whether the peep-proof is activated or not, depending on ambient environments, that is, to achieve a dynamical adjustment of a narrow visual angle and a wide visual angle, and a free switching between the peep-proof mode and the non-peep-proof mode.

Another embodiment of the present disclosure also provides a peep-proof display apparatus. FIG. 7 is a schematic view showing a structure of the peep-proof display apparatus 100 according to an embodiment of the present disclosure. As shown in FIG. 7, the peep-proof display apparatus 100 includes a display device 101 and a peep-proof device 102 stacked on the display device 101. The peep-proof device 102 may be the peep-proof device 1, 2, 3 or 4 as discussed in any one of the above embodiments. In the embodiments, the display device 101 is on the bottom side (light incidence side) of the peep-proof device 102, that is, the peep-proof device 102 is on the light exit side of the display device 101.

As discussed in the above embodiments, when no voltages are applied, the peep-proof device 102 may adjust the light emitted from the display device 101 through the laterally alignment film portion and the longitudinally alignment film portion, such that a part of the light emitted from the display device 101 is blocked by the peep-proof device, such that the light exits from the peep-proof device 102 in a narrow visual angle. Thus, images of the display device may be observed in the narrow visual angle in the peep-proof mode. In addition, when the a voltage is applied, the light emitted from the display device 101 exits from the peep-proof device 102 in full visual angle both through the lateral alignment film portion and through the longitudinal alignment film portion. In this way, images of the display device 102 may be observed in the full visual angle in the non-peep-proof mode.

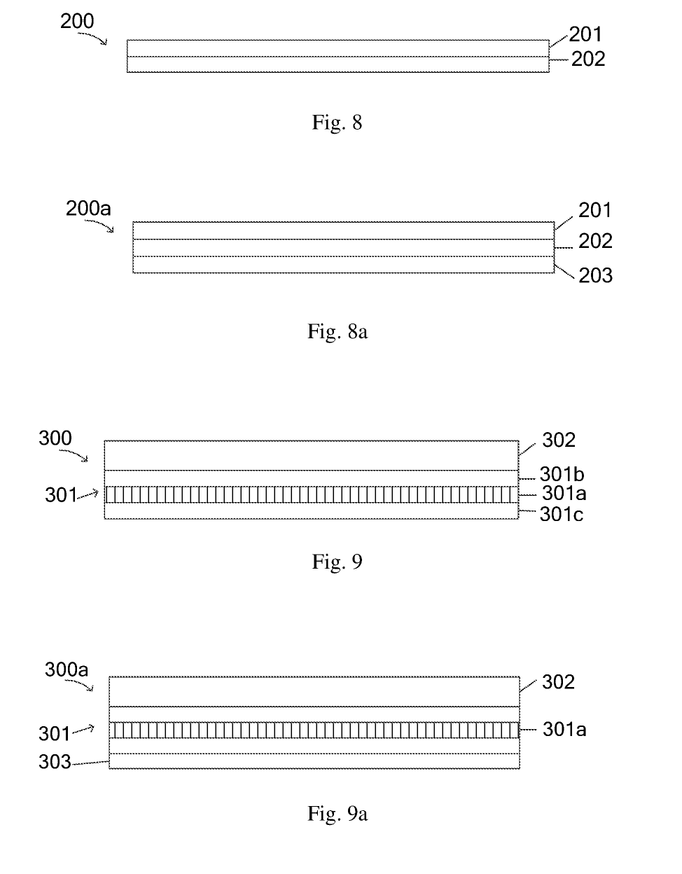

FIG. 8 is a schematic view showing a structure of the peep-proof display apparatus 200 according to another embodiment of the present disclosure. As shown in FIG. 8, the peep-proof display apparatus 200 includes a display device 201 and a peep-proof device 202 stacked on the display device 201. The peep-proof device 202 may be the peep-proof device 1, 2, 3 or 4 as discussed in any one of the above embodiments. In the embodiments, the display device 201 is on the top side (light exit side) of the peep-proof device 202, that is, the peep-proof device 202 is on the light incidence side (bottom side) of the display device 201.

In the above embodiments, similarly, when no voltages are applied, the peep-proof device 202 may adjust the light emitted to the display device 201 in advance through the laterally alignment film portion and the longitudinally alignment film portion, such that a part of the light emitted from the display device 201 is blocked by the peep-proof device 202, thereby the light being emitted towards the display device 201 in a narrow visual angle and exit from the top side (light exit side) of the display device 201 in a narrow visual angle. Thus, images of the display device may be observed in the narrow visual angle in the peep-proof mode. In addition, when the a voltage is applied, the light which is emitted towards the display device 201 exits from the peep-proof device 202 in full visual angle both through the lateral alignment film portion and through the longitudinal alignment film portion and passes through the display device 201. Thus, images of the display device 201 may be observed in the full visual angle in the non-peep-proof mode.

In the embodiments of FIG. 7 and FIG. 8, the display device may be a liquid crystal display device. In this circumstance, the display apparatus may further include a backlight device. The backlight device is on the bottom side of the display device, that is, the light incidence side, to supply a light source for the display device.

FIG. 7a is an example of a structure of the peep-proof display apparatus 100 shown in FIG. 7. In the example, the display device is a liquid crystal display device. As shown in FIG. 7a, the backlight device 103 is arranged on the bottom side of the peep-proof display apparatus 100 shown in FIG. 7, i.e., the bottom side of the display device 101, to form the peep-proof display apparatus 100a.

FIG. 8a is an example of a structure of the peep-proof display apparatus 200a shown in FIG. 8. In the example, the display device is a liquid crystal display device. As shown in FIG. 8a, the backlight device 203 is arranged on the bottom side of the peep-proof display apparatus 200 shown in FIG. 8, i.e., the bottom side of the peep-proof device 202, to form the peep-proof display apparatus 200a.

In accordance with other embodiments, the display device may also be an organic light emitting diode (OLED) display device. The peep-proof device is on the light exit side of the display device. In this circumstance, the backlight device may be dispensed.

FIG. 9 is a schematic view showing a structure of the peep-proof display apparatus 300 according to another embodiment of the present disclosure. As shown in FIG. 9, the peep-proof display apparatus 300 includes a display device 301 and a guest-host liquid crystal cell 302. The display device 301 is on the light incidence side of the guest-host liquid crystal cell 302. As the display device 301 includes a polarizer 301a in itself. It is sufficient for the peep-proof display apparatus 300 to only comprise the guest-host liquid crystal cell 302 which is the liquid crystal cell 10 in the peep-proof device 1, 2, 3 or 4 as discussed in any one of the above embodiments. In accordance with the embodiment, the polarizer 301a is arranged in the display device 301. On other words, the polarizer 301a which is included in the display device 301 itself may be used as the polarizer of the peep-proof device, and form the peep-proof device similar to the above embodiment in combination with the guest-host liquid crystal cell 302. The skilled person in the art may understand that the display device 301 may also include structures such as an upper substrate 301b and a lower substrate 301c. The details of these structures will be omitted here.

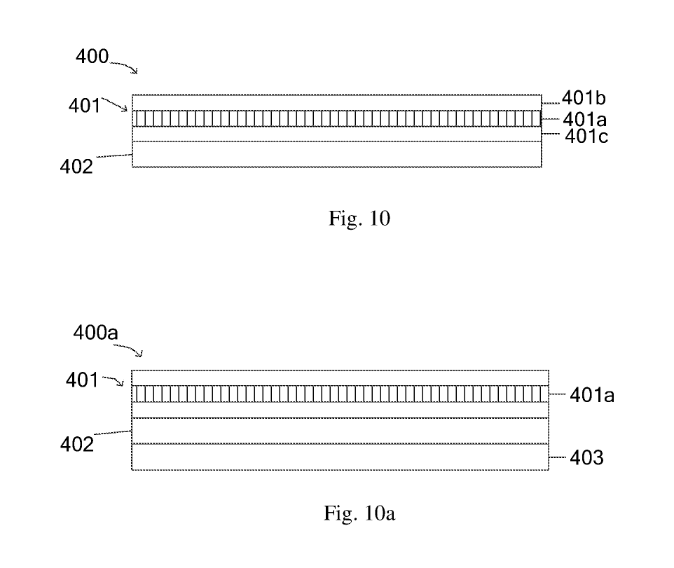

FIG. 10 is a schematic view showing a structure of the peep-proof display apparatus 400 according to another embodiment of the present disclosure. As shown in FIG. 10, the peep-proof display apparatus 400 includes a display device 401 and a guest-host liquid crystal cell 402. The display device 401 is on the light exit side of the guest-host liquid crystal cell 402. The guest-host liquid crystal cell 402 is on the light exit side of the display device 401. The display device 401 includes a polarizer 401a. The guest-host liquid crystal cell 402 may be the liquid crystal cell 10 in the peep-proof device 100, 200, 300 or 400 as discussed in any one of the above embodiments. In accordance with the embodiment, similar to the embodiment in FIG. 9, the polarizer 401a is arranged in the display device 401. On other words, the polarizer 401a which is included in the display device 401 itself may be used as the polarizer of the peep-proof device, and form the peep-proof device similar to the above embodiment in combination with the guest-host liquid crystal cell 402. The skilled person in the art may understand that the display device 401 may also include structures such as an upper substrate 401b and a lower substrate 401c. The details of these structures will be omitted here.

In the embodiment shown in FIG. 9 or FIG. 10, the display device may be a liquid crystal display device. In such circumstance, the display apparatus further includes a backlight device. The backlight device is arranged on the bottom side of the display device, i.e., the light incidence side of the display device, to supply the light source for the display device.

FIG. 9a is an example of a structure of the peep-proof display apparatus 300a shown in FIG. 9. In the example, the display device 301 is a liquid crystal display device. As shown in FIG. 9a, the backlight device 303 is arranged on the bottom side (light incidence side) of the peep-proof display apparatus 300 shown in FIG. 9, to form the peep-proof display apparatus 300a.

FIG. 10a is an example of a structure of another peep-proof display apparatus 400a shown in FIG. 10. In the example, the display device 401 is a liquid crystal display device. As shown in FIG. 10a, the backlight device 403 is arranged on the bottom side of the peep-proof display apparatus 400 shown in FIG. 10, i.e., on the bottom side of the guest-host liquid crystal cell 402, to form the peep-proof display apparatus 400a.

In accordance with other embodiments, the display device may alternatively be an OLED display device. The peep-proof device is arranged on the light exit side of the display device. In such circumstance, the backlight device may be dispensed.

The embodiments of the present disclosure provide a peep-proof device. The alignment films in the guest-host liquid crystal cell are arranged to include the first alignment film portions and the second alignment film portions arranged alternately and each of the first alignment film portions has the alignment direction perpendicular to the alignment direction of each of the second alignment film portions. In this way, the light passing through the liquid crystal cell and the polarizer provides bright portions at the location corresponding to the first alignment film portions and dark portions at the location corresponding to the second alignment film portions, so as to limit the light emitting angle and to achieve the peep-proof.

The peep-proof device according to other embodiments, may be allowed to switch between the peep-proof mode and the non-peep-proof mode in various applications.

Some embodiments of the present disclosure have been described by way of examples. However, the skilled person in the art would appreciate that various modifications and variations of the embodiments of the present disclosure may be made without departing from the principles and spirit of the present disclosure. All of these modifications and variations should fall within the protect scope of the present disclosure. Therefore, the scope of the present disclosure should be defined by the scope of the appended claims.

1. A peep-proof device, comprising:
a guest-host liquid crystal cell comprising a guest-host liquid crystal layer, and
a polarizer on the guest-host liquid crystal cell,
wherein the guest-host liquid crystal cell comprises a first alignment film, the first alignment film comprising first alignment film portions and second alignment film portions arranged alternately, and each of the first alignment film portions having an alignment direction substantially perpendicular to an alignment direction of each of the second alignment film portions.

2. The peep-proof device according to claim 1, wherein the guest-host liquid crystal cell further comprises a second alignment film and the guest-host liquid crystal layer of the guest-host liquid crystal cell is between the first alignment film and the second alignment film.

3. The peep-proof device according to claim 2, wherein the second alignment film comprises third alignment film portions and fourth alignment film portions arranged alternately, and
wherein each of the first alignment film portions of the first alignment film is aligned with one of the third alignment film portions of the second alignment film in a thickness direction of the guest-host liquid crystal cell, and the first alignment film portions and the third alignment film portions have same alignment directions, and
wherein each of the second alignment film portions of the first alignment film is aligned with one of the fourth alignment film portions of the second alignment film in the thickness direction of the guest-host liquid crystal cell, and the second alignment film portions and the fourth alignment film portions have same alignment directions.

4. The peep-proof device according to claim 2, further comprising:
a first electrode on a side of the first alignment film away from the guest-host liquid crystal layer; and
a second electrode on a side of the second alignment film away from the guest-host liquid crystal layer.

5. The peep-proof device according to claim 4, further comprising:
a first substrate on a side of the first electrode away from the guest-host liquid crystal layer; and
a second substrate on a side of the second electrode away from the guest-host liquid crystal layer.

6. The peep-proof device according to claim 1, wherein the polarizer is on a light exit side or a light incidence side of the guest-host liquid crystal cell.

7. A peep-proof display apparatus comprising:
a display device; and
the peep-proof device according to claim 1.

8. The peep-proof display apparatus according to claim 7, wherein the display device is on a light exit side or a light incidence side of the peep-proof device.

9. The peep-proof display apparatus according to claim 7, wherein the display device is a liquid crystal display device and the peep-proof display apparatus further comprises a backlight device on a light incidence side of the display device.

10. The peep-proof display apparatus according to claim 7, wherein the display device is an organic light emitting diode display device.

11. A peep-proof display apparatus comprising:
a display device; and
a guest-host liquid crystal cell,
wherein the guest-host liquid crystal cell comprises a first alignment film, the first alignment film comprising first alignment film portions and second alignment film portions arranged alternately, and each of the first alignment film portions having an alignment direction substantially perpendicular to an alignment direction of each of the second alignment film portions.

12. The peep-proof display apparatus according to claim 11, wherein the guest-host liquid crystal cell further comprises a second alignment film and a guest-host liquid crystal layer of the guest-host liquid crystal cell is between the first alignment film and the second alignment film.

13. The peep-proof display apparatus according to claim 12, wherein the second alignment film comprises third alignment film portions and fourth alignment film portions arranged alternately, and
wherein each of the first alignment film portions of the first alignment film is aligned with one of the third alignment film portions of the second alignment film in a thickness direction of the guest-host liquid crystal cell, and the first alignment film portions and the third alignment film portions have same alignment directions, and
wherein each of the second alignment film portions of the first alignment film is aligned with one of the fourth alignment film portions of the second alignment film in the thickness direction of the guest-host liquid crystal cell, and the second alignment film portions and the fourth alignment film portions have same alignment directions.

14. The peep-proof display apparatus according to claim 11, wherein the display device is on a light exit side or a light incidence side of the guest-host liquid crystal cell.

15. The peep-proof display apparatus according to claim 11, wherein the display device is a liquid crystal display device and the peep-proof display apparatus further comprises a backlight device on a light incidence side of the display device.

16. The peep-proof display apparatus according to claim 11, wherein the display device is an organic light emitting diode display device.

17. (canceled)

18. The peep-proof device according to claim 1, wherein the polarizer has a polarization orientation substantially parallel with the alignment direction of the first alignment film portions or the alignment direction of the second alignment film portions.

19. The peep-proof display apparatus according to claim 10, wherein the peep-proof device is between the display device and the backlight device.

20. The peep-proof display apparatus according to claim 13, wherein the display device comprises a polarizer.

21. The peep-proof display apparatus according to claim 18, wherein the peep-proof device is between the display device and the backlight device.
